(19) United States
(12) Patent Application Publication
(10) Pub. No.: US 2010/0047072 A1
(43) Pub. Date: Feb. 25, 2010

(54) TURBOCHARGER

(75) Inventor: Christian Holzschuh, Alzey (DE)

Correspondence Address: BORGWARNER INC. C/O PATENT CENTRAL LLC, 1401 HOLLYWOOD BOULEVARD, HOLLYWOOD, FL, 33020-5237, US

(73) Assignee: BORGWARNER INC., Auburn Hills, MI (US)

(21) Appl. No.: 12/515,434

(22) PCT Filed: Nov. 27, 2007
(86) PCT No.: PCT/EP2007/010301

§ 371 Date: May 19, 2009

(30) Foreign Application Priority Data
Nov. 29, 2006 (DE) 10 2006 056 386.7

(51) Int. Cl. F04D 29/26; B23P 11/00

(52) U.S. Cl. 416/204 R; 29/889.21

(57) ABSTRACT

The invention relates to a turbocharger (1), comprising a compressor (8), with a compressor wheel (9) fixed to one end of a rotor shaft (6) and a turbine (2), with a turbine rotor (10) which has a turbine wheel (5) with a fixing section (11) which may be connected to a connector part (12) of the rotor shaft (6) by means of a connector device (14, 15), said connector device (14, 15) being designed as a combination of a press connection and a positive-fit connection, the cross-section (Q1, Q1′, Q1″) of the connector part (12) being orbiform

The invention relates to a turbocharger according to the preamble of claim 1, to a turbine rotor according to the preamble of claim 11, and to a process for producing a turbine rotor of this type as claimed in claim 13.

A turbocharger of the generic type is known from EP 1 621 774 A2.

The object of the present invention is to provide a turbocharger for an internal combustion engine according to the preamble of claim 1 and a turbine rotor of a turbocharger of this type which makes it possible to provide a connection device between the turbine rotor and the turbine wheel which has a simple design, is easy to produce and simultaneously satisfies the conventional demands with respect to strength and heat resistance.

In terms of the turbocharger according to the invention, this object is achieved by means of the features of claim 1. In terms of the turbine rotor and the process for producing a turbine rotor, the object is achieved by means of the features of claims 11 and 13.

The claims which refer back respectively to independent claims 1, 11 and 13 contain advantageous developments of the invention.

By way of example, in particular in the case of a turbine rotor made from TiAl (titanium aluminide alloy) and a rotor shaft made from steel such as, in particular, valve steel or martensitic, austenitic or heat-resistant steel, it is therefore possible according to the invention to align the axes of the turbine wheel and of the rotor shaft satisfactorily with one another and to reduce the conduction of heat from the turbine wheel to the rotor shaft.

In addition, there is the advantage that the connection device of the turbocharger according to the invention or of the turbine rotor according to the invention does not require additional aids, for example a solder.

With respect to further advantages of the invention, reference can be made to the following list:
simple construction,
small number of parts,
simple, reliable preparation of the individual parts of the turbine rotor according to the invention,
relatively simple joining process,
similar physical values of the materials of the turbine rotor are utilized,
changes in the microstructure of the materials are avoided owing to the reduced influx of heat during the joining operation,
avoiding cracks in the titanium aluminide alloy as a result of the parts of the turbine rotor being machined with geometrically undefined cutting (grinding), as a result of which the material has residual compressive stresses which are advantageous for avoiding cracks,
pre-turned rotor shafts are used, in which case the narrow fit and the small radial play of the two components of the rotor according to the invention make it possible to join a rotor shaft which is already pre-turned to grinding size, and in the best case even a finish-turned rotor shaft can be joined. This results in the further advantage that the emphasis can be placed on reducing manufacturing costs, and in addition to this it is possible to reduce the mechanical loading on the parts to be joined as a result of grinding, which induces a compressive stress in the surfaces, and this has a positive effect on the strength of the connection.

Further details, advantages and features of the present invention become apparent from the following description of exemplary embodiments with reference to the appended drawing, in which:

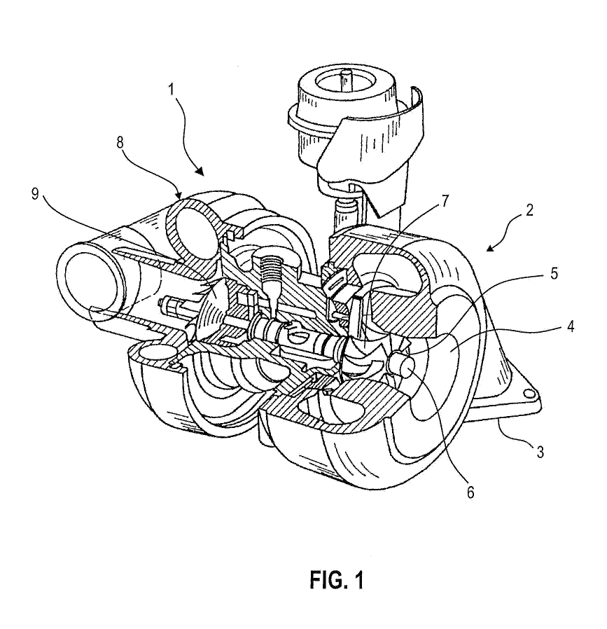

FIG. 1 shows a partially cut-away perspective illustration of a turbocharger according to the invention,

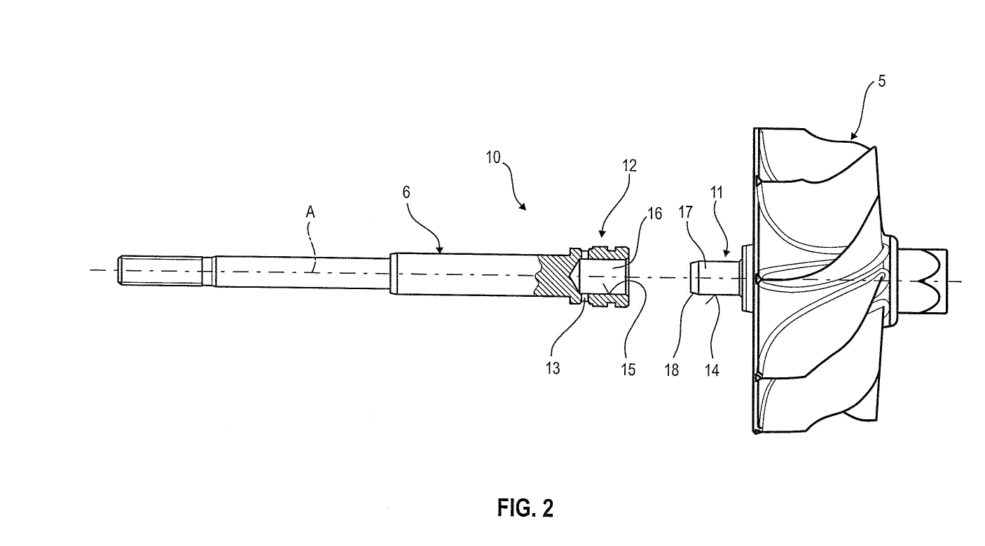

FIG. 2 shows a partially cut-away side view of a turbine rotor according to the invention, which is part of the turbocharger in FIG. 1, before the rotor shaft and the turbine wheel are connected,

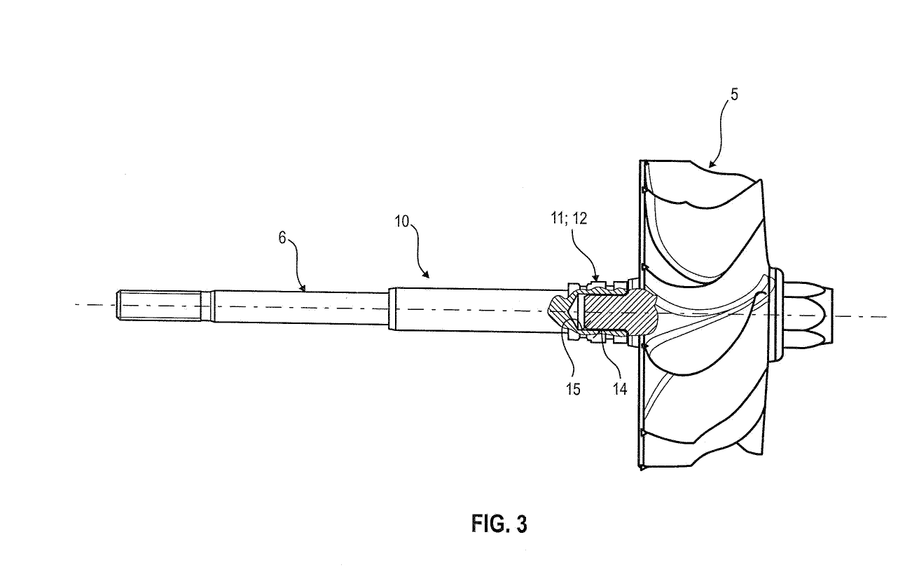

FIG. 3 shows an illustration, corresponding to FIG. 2, of the turbine rotor after the rotor shaft and the turbine wheel have been connected, and

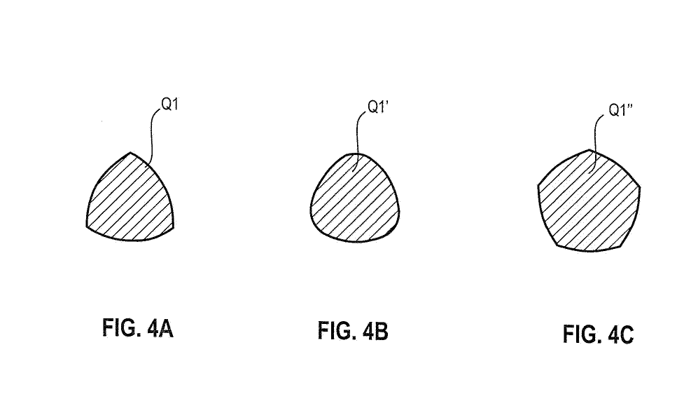

FIGS. 4A-4C show different variants of cross sections of a journal of a connection device of the turbine rotor according to the invention.

FIG. 1 shows a turbocharger 1 according to the invention in a partially cut-away illustration.

The turbocharger 1 has a turbine 2 which comprises an exhaust-gas inlet opening 3 and an exhaust-gas outlet opening 4.

Furthermore, a turbine wheel 5, which is fastened to one end of a rotor shaft 6, is arranged in the casing of the turbine 2.

A multiplicity of blades, only the blade 7 of which can be seen in FIG. 1, are arranged in the turbine casing between the exhaust-gas inlet opening 3 and the turbine wheel 5.

Furthermore, the turbocharger 1 has a compressor 8 comprising a compressor wheel 9 which is fastened to the other end of the rotor shaft 6 and is arranged in the housing of the compressor 8.

Of course, the turbocharger 1 according to the invention also has all the other conventional components of a turbocharger, such as a bearing housing with a bearing housing unit etc., but these are not described hereinbelow since they are not required for explaining the principles of the present invention.

FIG. 2 shows a partially sectional illustration of a turbine rotor 10, before the rotor shaft 6 and the turbine wheel 5 of said turbine rotor are connected to one another.

As shown in FIG. 2, one of the ends of the rotor shaft 6 is provided with a connection part 12 which is shown in section in FIG. 2. It becomes clear from this illustration that, in the embodiment illustrated in FIG. 2, the connection part 12 has a centrical bore 16 which is provided with a vent bore 13 running transversely with respect to the mid-axis A of the rotor shaft 6.

The turbine wheel 5 has a fastening portion which is embodied, by way of example, as a journal 17. FIG. 2 also shows the outer circumferential surface or lateral surface 14 of the journal 17 and the inner circumferential surface or inner lateral surface 15 of the bore 16, and these together form a connection device which is embodied, according to the invention, as a press connection. According to the invention, the dimensions of the bore 16 and of the journal 17 are provided such that an oversize fit, which is configured according to DIN ISO 286 T2, can be produced in order to join the rotor shaft 6 and the turbine wheel 5 together.

By way of example, an oversize fit H6/r5 may be involved.

The finish-joined turbine rotor arrangement 10 can be gathered from FIG. 3, wherein the vent bore 13 ensures that sealing air, which occurs when the parts are being joined and would represent an otherwise included air volume, can escape.

Although, in FIGS. 2 and 3, the turbine wheel 5 is provided with a journal 17 and the rotor shaft 6 is provided with a correspondingly dimensioned bore 16, these parts can also be connected by means of the reverse arrangement, that is to say by a rotor shaft 6 having a journal and a turbine wheel comprising a correspondingly embodied bore.

FIGS. 4A-4C show different cross-sectional forms which are conceivable for the outer surface 14 of the journal 17.

FIGS. 4A-4C show cross sections which are in the form of an orbiform and are designated by Q1, Q1′ and Q1″.

In this case, the cross section Q1 is a triangular orbiform, this term representing a cross section which illustrates a figure of identical thickness for every direction.

The cross-sectional form Q1′ represents the orbiform according to FIG. 4A with rounded corners.

By way of example, FIG. 4C illustrates a pentagonal orbiform Q1″. In principle, other forms such as, in particular, a tetragonal orbiform are also conceivable.

The advantage of this cross-sectional form can be seen in that force or torque transmission is ensured not only by the press fit but also by additional positive locking.

With respect to the process according to the invention, reference should also be made to the following:

The turbine rotor 10 according to the invention may preferably be made of the material TiAI and comprise a turbine wheel 5 produced by investment casting. In turn, the rotor shaft 6 is preferably produced from valve steel or heat-resistant, martensitic or austenitic steel.

The process according to the invention for producing the above-described turbine rotor 10 is distinguished, inter alia, in that the connection between the two components 5 and 6 can be established without using an additional aid, for example a solder. The tight fit required for connecting these parts 5, 6 is dependent on the size of the components 5, 6 and the load.

Preferably required narrow tolerances of the journal 17 of the turbine wheel 5 can be obtained by grinding, it being possible for the turbine wheel 5 to have compressive stresses at its joining surface in the press fit, the compressive stresses being conducive to a possibly relatively brittle material behavior.

According to the invention, the rotor shaft 6 is provided with an exact-fit bore 16. In this case, it is preferable for the journal of the turbine wheel to have an insertion chamfer or bevel 18 which makes it easier to join the two parts 5, 6. The material combination TiAl/steel can be chosen differently; however, a valve steel represents a preferred embodiment since this results in relatively identical coefficients of thermal expansion between the turbine wheel 5 and the rotor shaft 6, over which permit a secure fit to be obtained different temperatures.

As explained above, the press fit is obtained by the two mutually abutting circumferential surfaces or lateral surfaces 14 and 15 of the journal 17 or of the bore 16, it being possible to join the turbine wheel 5 and the rotor shaft 6 by using an additional joining device which heats the shaft, if the latter is provided with the bore 16, uniformly over its circumference and inserts the journal 17 of the turbine wheel 5 into the uniformly heated shaft as far as it will go.

In addition, it is advantageous in this arrangement that both components in the joining process are joined together with a particular load which is, for example, 0.1 N/mm² or higher, but less than the yield stress of the turbine wheel 5 and of the rotor shaft 6.

Furthermore, the joining operation can take place under a protective atmosphere, for example of inert gas or reduction gas, in which one of the components in the joining process is heated to the required connection temperature by radio-frequency heating.

If, however, as explained above, the journal 17 is fitted on the rotor shaft 6 and the bore 16 is fitted in the turbine wheel 5, a medium which greatly reduces the temperature, such as, for example, liquid nitrogen, can be used to cool the shaft in a joining device to such an extent that it fits into the bore 16 in the turbine wheel 5.

With respect to the vent bore 13 which has likewise already been explained above, it should be emphasized that it is possible to provide at least one bore, but also a plurality of such bores.

In addition to the written explanation of the features of the invention above, explicit reference is made to the illustrative explanation of the invention in FIGS. 1 to 4C for additional disclosure thereof.

### LIST OF REFERENCE SYMBOLS

1 Turbocharger/exhaust-gas turbocharger
2 Turbine
3 Exhaust-gas inlet opening
4 Exhaust-gas outlet opening
5 Turbine wheel
6 Rotor shaft
7 Blades
8 Compressor
9 Compressor wheel
10 Turbine rotor
11 Fastening portion
12 Connection part
13 Vent bore
14, 15 Connection device=lateral surfaces of 11 and 12
16 Bore
17 Journal
18 Insertion chamfer/bevel
Q1, Q1′, Q1″ Cross sections (orbiform in different variants)

1. A turbocharger (1)
comprising a compressor (8) having a compressor wheel (9) which is fixed to one end of a rotor shaft (6); and
comprising a turbine (2) having a turbine rotor (10) which comprises a turbine wheel (5) having a fastening portion (11) connected to a connection part (12) of the rotor shaft (6) by means of a connection device (14, 15),
wherein the connection device (14, 15) is a combination of a press connection and a positive-locking connection, wherein the cross section (Q1, Q1′, Q1″) of the connection part (12) of the rotor shaft (6) is an orbiform.

2. The turbocharger as claimed in claim 1, wherein the fastening portion (11) is a bore (16) and the connection part (12) is a journal (17).

3. The turbocharger as claimed in claim 1, wherein the fastening portion (11) is a journal (17) and the connection part (12) is a bore (16).

4. The turbocharger as claimed in claim 1, wherein the orbiform (Q1′) is a triangle of arcs.

5. The turbocharger as claimed in claim 1, wherein the orbiform (Q1″) is an orbiformal polygon.

6. The turbocharger as claimed in claim 1, wherein the material of the turbine wheel (5) is TiAl.

7. The turbocharger as claimed in claim 1, wherein the material of the rotor shaft (6) is valve steel or a martensitic, heat-resistant or austenitic steel.

8. The turbocharger as claimed in claim 3, wherein the bore (16) is provided with a vent bore (13).

9. A turbine rotor of a turbocharger (1)
comprising a turbine wheel (5) having a fastening portion (11), and
comprising a rotor shaft (6) having a connection part (12) connected to the fastening portion (11) of the turbine wheel (5) by means of a connection device (14, 15),
wherein the connection device (14, 15) is a combination of a press connection and a positive-locking connection, wherein the cross section (Q1, Q1′, Q1″) of the connection part (12) is embodied as an orbiform.

10. The turbine rotor as claimed in claim 9, wherein the fastening portion (11) is a bore (16) and the connection part (12) is a journal (17).

11. A process for producing a turbine rotor (10) of a turbocharger (1), wherein the turbine rotor (10) has a turbine wheel (5) provided with a fastening portion (11) which can be connected to a connection part (12) of a rotor shaft (6) by means of a connection device (14, 15), wherein the dimensions and the cross-sectional form of the fastening portion (11) and of the connection part (12) are selected such that a combined press/positive-locking connection is established as the connection device (14, 15), the process comprising press-fitting together said turbine wheel (5) fastening portion (11) and said rotor shaft (6) connection device (14, 15).

12. The process as claimed in claim 11, wherein the connection part (12) of the rotor shaft (6) is a bore (16) and the fastening portion (11) is a journal (17), wherein the press fit is produced by heating the bore (16) uniformly over its circumference and then joining it to the journal (17).

13. The process as claimed in claim 11, wherein the fastening portion (11) is a bore (16) and the connection part (12) of the rotor shaft (6) is a journal which, in order to produce the press fit, is cooled before the joining operation to such an extent that it is possible to bring the bore and the journal together, after which the connection fit is produced once the journal has been heated.

14. The process as claimed in claim 11, wherein the bore (16) is provided with a vent bore (13).

15. The process as claimed in claim 11, wherein the rotor shaft (6) is pre-turned or finish-turned.

16. The process as claimed in claim 11, wherein the depth of the bore (16) is set to be greater than the length of the journal (17), and the vent bore (13) is arranged in a region of the bore (16) which is not covered by the journal (17) in the state in which the rotor shaft (6) and the turbine wheel (5) have been joined together.
